(19) United States
(12) Patent Application Publication
(10) Pub. No.: US 2026/0039662 A1
(43) Pub. Date: Feb. 5, 2026

(54) METHOD OF ACCESSING A WEB APPLICATION RUNNING IN A REMOTE DATA CENTRE AT A CLIENT ENDPOINT DEVICE RUNNING A FIRST WEB BROWSER

(71) Applicant: Huawei Cloud Computing Technologies Co., Ltd., Gui'an New District (CN)

(72) Inventors: Peter Finkelshtein, Hod Hasharon (IL); Avi Chalbani, Hod Hasharon (IL)

(73) Assignee: Huawei Cloud Computing Technologies Co., Ltd., Gui'an New District (CN)

(21) Appl. No.: 19/299,126

(22) Filed: Aug. 13, 2025

Related U.S. Application Data
(63) Continuation of application No. PCT/EP2023/053427, filed on Feb. 13, 2023.

(51) Int. Cl. H04L 9/40; G06F 9/451

(52) U.S. Cl. CPC H04L 63/10; G06F 9/451; H04L 63/029

(57) ABSTRACT

A method of accessing, at a client endpoint device running a first web browser, a web application running in a remote data centre is provided. The method includes sending a request to access the web application to a gateway at the remote data centre; receiving hypervisor script code from the gateway; executing the received hypervisor script code at the client endpoint device using the first web browser; displaying, on a screen of the client endpoint device, a graphical image of a user interface screen of the web application running at the remote data centre. In response to such received user interaction events, a second web browser fetches components of the web application over the secure application access tunnel connection and renders the graphical image of the user interface screen of the web application by invoking an HTML canvas function of the first web browser.

### CROSS-REFERENCE TO RELATED APPLICATIONS

This application is a continuation of International Application No. PCT/EP2023/053427, filed on Feb. 13, 2023, the disclosure of which is hereby incorporated by reference in its entirety.

### TECHNICAL FIELD

The disclosure relates generally to a method of accessing a web application running in a remote data centre at a client endpoint device that runs a first web browser and more particularly, the disclosure relates to a client endpoint device running a first web browser, accessing a web application running in a remote data centre.

### BACKGROUND

Enterprise applications are large software system platforms designed to integrate computer systems that run all phases of an enterprise's operations to facilitate cooperation and coordination of work across the enterprise. An existing technology enables users (e.g. employees) to use an enterprise application for providing services and managing assets. In recent times, many users are working from home. The “Work from home” environment may cause security incidents related to accessing the enterprise applications from an untrusted/unmanaged environment. The Bring your own device (BYOD)/“Work from home” environment may become quite problematic for the enterprises that need to take care regarding their assets.

In order to access enterprise applications, an existing solution provides the users (e.g. employees) with hardware and a preinstalled setup of software. Another existing solution employs Virtual Desktop Interface (VDI) technology that utilizes a resource layer to manage a secure runtime environment/applications and provides a visual interface to a client. That is, for every connection, a dedicated browser instance needs to be executed in the resource layer. The main disadvantage of this existing solution is the excess costs of managing the resource layer and inefficient performance due to networking issues.

Further, this existing solution requires a VDI client installation on an endpoint/a user device. With this Virtual Private Network (VPN) client, a secure communication may be established and appropriate resources may be allocated. In this existing solution, the fully managed client environment provides the hardware and the installed software. The provided resource may be entered into an enterprise security perimeter, which is a complex and an expensive solution. A malicious application may run on the endpoint/user device and may access sensitive data stored on the host/enterprise application. The malware on the undamaged personal computer (PC) may access browser files (e.g. cache, cookies, downloaded content, html page elements, forms data, local storage, etc.) and the resource layer may send the same to a third party. The malicious/compromised application running in another tab/browser can access an enterprise application to steal the data. The malicious plugin/application may access sensitive information like cookies and forms the data.

Yet another existing solution provides a local secure browser at the client device for remotely accessing the enterprise application. The browser is fully managed by the organization/enterprise. Typically, the local secure browser runs as a second browser on the client device and has all relevant security features required by the enterprise. The local secure browser is a piece of software that needs to support multiple operation systems, kernel versions as well as different architectures. Furthermore, this existing solution requires the installation of the software on the endpoint/user device. The main disadvantages of this existing solution are usability (i.e. the installation of 2 browsers), security (i.e. non-isolated browsers may be exposed to computer threats), environment/platform defendant (i.e. need to have a separate version for each environment).

Therefore, there arises a need to address the aforementioned technical problems/drawbacks in providing access to a web application from an untrusted environment.

### SUMMARY

It is an object of the disclosure to provide a method and a system of accessing, at a client endpoint device running a first web browser, a web application running in a remote data centre and to provide the client endpoint device that runs the first web browser, and accesses the web application running in the remote data centre, while avoiding one or more disadvantages of prior art approaches.

This object is achieved by the features of the independent claims. Further, implementation forms are apparent from the dependent claims, the description, and the figures.

According to a first aspect, there is provided a method of accessing, at a client endpoint device running a first web browser, a web application running in a remote data centre. The method includes sending a request to access the web application to a gateway at the remote data centre. The method includes receiving hypervisor script code from the gateway in response to the request. The method includes executing the received hypervisor script code at the client endpoint device using the first web browser. Executing the received hypervisor script code causes the client endpoint device to: (i) retrieve a second web browser from the gateway at the remote data centre; (ii) launch the retrieved second web browser at the client endpoint device within the first web browser; and (iii) establish a secure application access tunnel connection via the second web browser to the gateway. The method includes displaying, on a screen of the client endpoint device, a graphical image of a user interface screen of the web application running at the remote data centre, by receiving user interaction events input by a user of the first web browser of the client endpoint device and in response to such received user interaction events, the second web browser fetches components of the web application over the secure application access tunnel connection and renders the graphical image of the user interface screen of the web application by invoking a HyperText Markup Language (HTML) canvas function of the first web browser.

The method reduces the total costs of service by eliminating the need for a resource layer because the web browsers (i.e. the first and second web browsers) and the web application access components are running at the client endpoint device and not on the enterprise resources/resource layer. The method improves security by retrieving and launching the second web browser at the client endpoint device within the first web browser from an untrusted environment (i.e. isolating the second web browser from the untrusted environment). The method improves the performance of accessing the web application by rendering locally at the client endpoint device instead of rendering at the remote data centre. The method employs any existing browser/embedded browser, thereby eliminating the need for an additional client software installation required. The method provides an architecture independent platform, where any client endpoint device with an installed browser (e.g. Chrome, Firefox, Edge, or Safari, etc.) can be implemented. The method may seamlessly be interpreted and executed by a JavaScript engine and therefore the method is not intrusive and does not require any change in the web application. The method provides a single management platform for the security policy that can be introduced. The method enables the execution of the web application only an isolated JavaScript engine with a local memory without access to the web application and therefore malware or malicious browser plugin cannot exploit vulnerabilities in the web application.

The method enables a policy-controlled output of information such as a printer, a clipboard device and a storage device. The method enables data access policies to allow users to save data locally at the client endpoint device. For example, a user (e.g. an employee) wants to save his paycheck on the client endpoint device itself. The method provides a zero configuration framework (i.e. without the need to install any additional software such as plugins/Virtual Private Network/browser/Virtual Desktop Interface client) to enable users to use and leverage enterprise web application from the untrusted source/environment. The client endpoint device can use any enterprise web application after an authentication process and no further actions are required. The method enables a secure access for any public web application.

The method provides a new architecture for the enterprise web application over a virtual embedded browser, thereby significantly reducing the operational cost. The method is a managed service (i.e. policy change may be enforced immediately) and controls the data lost prevention strategies. The method employs the embedded secure browser/second web browser that is executed within the first browser that is installed on the client endpoint device for accessing the web application. The secure second web browser can be provided as a service for private customers.

Optionally, the secure application access tunnel connection is a Virtual Private Network (VPN) tunnel connection. The gateway may be a Web Application Firewall gateway or a Cloud Access Security Broker gateway.

Optionally, the data that is persisted as a result of the access to the web application is sent by the second web browser over the secure application access tunnel connection and stored at the remote data centre. Optionally, the data that is persisted as a result of the access to the web application is encrypted by the second web browser and stored locally at the client endpoint device. Optionally, the second web browser is in a Web Assembly format.

Optionally, a user interaction event interface of the second web browser is exposed to the first web browser. A canvas interface of the second web browser may be exposed to the first web browser. A VPN client may be included in the second web browser.

Optionally, the data that is persisted includes at least one of cookies, a Document Object Model tree and a content downloaded via the web application.

According to a second aspect, there is provided a system including means adapted for carrying out all the steps of the method according to any preceding method claims.

The system reduces the total costs of service by eliminating the need for a resource layer because the web browsers (i.e. the first and second web browsers) and the web application access components are running at the client endpoint device and not on the enterprise resources/resource layer. The system improves security by retrieving and launching the second web browser at the client endpoint device within the first web browser from an untrusted environment (i.e. isolating the second web browser from the untrusted environment). The system improves the performance of accessing the web application by rendering locally at the client endpoint device instead of rendering at the remote data centre. The system employs any existing browser/embedded browser, thereby eliminating the need for an additional client software installation required.

According to a third aspect, there is provided a computer program including instructions for carrying out all the steps of the method according to any preceding method claim, when the computer program is executed on a computer system.

According to a fourth aspect, there is provided a client endpoint device running a first web browser, accessing a web application running in a remote data centre. The client endpoint device is configured to (i) send a request to access the web application to a gateway at the remote data centre; (ii) receive hypervisor script code from the gateway in response to the request; (iii) execute the received hypervisor script code at the client endpoint device using the first web browser; and (iv) display, on a screen of the client endpoint device, a graphical image of a user interface screen of the web application running at the remote data centre, by receiving user interaction events input by a user of the first web browser of the client endpoint device and in response to such received user interaction events, the second web browser fetches components of the web application over the secure application access tunnel connection and renders the graphical image of the user interface screen of the web application by invoking a HyperText Markup Language (HTML) canvas function of the first web browser. Executing the received hypervisor script code causes the client endpoint device to: (a) retrieve a second web browser from the gateway at the remote data centre; (b) launch the retrieved second web browser at the client endpoint device within the first web browser; and (c) establish a secure application access tunnel connection via the second web browser to the gateway.

The client endpoint device reduces the total costs of service by eliminating the need for a resource layer because the web browsers and the web application access components are running at the client endpoint device and not on the enterprise resources/resource layer. The client endpoint device improves security by retrieving and launching the second web browser at the client endpoint device within the first web browser from an untrusted environment (i.e. isolating the second web browser from the untrusted environment). The client endpoint device improves the performance of accessing the web application by rendering locally at the client endpoint device instead of rendering at the remote data centre. The client endpoint device employs any existing browser/embedded browser, thereby eliminating the need for an additional client software installation required.

Therefore, in contradistinction to the existing solutions, the method reduces the total costs of service by eliminating the need for a resource layer because the web browser and the web application access components are running at the client endpoint device and not on the enterprise resources/resource layer and improves security by retrieving and launching the second web browser at the client endpoint device within the first web browser from an untrusted environment (i.e. isolating the second web browser from the untrusted environment).

These and other aspects of the disclosure will be apparent from the implementation(s) described below.

### BRIEF DESCRIPTION OF DRAWINGS

Implementations of the disclosure will now be described, by way of example only, with reference to the accompanying drawings, in which:

FIG. 1 illustrates a system for accessing a web application running in a remote data centre at a client endpoint device running a first web browser in accordance with an implementation of the disclosure;

FIG. 2 illustrates a client endpoint device running a first web browser for accessing a web application running in a remote data centre in accordance with an implementation of the disclosure;

FIGS. 3A-3B are flow diagrams that illustrate a method of accessing, at a client endpoint device running a first web browser, a web application running in a remote data centre in accordance with an implementation of the disclosure; and

FIG. 4 is an illustration of a computer system (e.g. a client endpoint device) in which the various architectures and functionalities of the various previous implementations may be implemented.

### DETAILED DESCRIPTION OF THE DRAWINGS

Described below are implementations of a method and a system of accessing, at a client endpoint device running a first web browser, a web application running in a remote data centre and also of the client endpoint device that runs the first web browser, and accesses the web application running in the remote data centre.

To make solutions of the disclosure more easily comprehensible for a person skilled in the art, the following implementations of the disclosure are described with reference to the accompanying drawings.

Terms such as “a first”, “a second”, “a third”, and “a fourth” (if any) in the summary, claims, and foregoing accompanying drawings of the disclosure are used to distinguish between similar objects and are not necessarily used to describe a specific sequence or order. It should be understood that the terms so used are interchangeable under appropriate circumstances, so that the implementations of the disclosure described herein are, for example, capable of being implemented in sequences other than the sequences illustrated or described herein. Furthermore, the terms “include” and “have” and any variations thereof, are intended to cover a non-exclusive inclusion. For example, a process, a method, a system, a product, or a device that includes a series of steps or units, is not necessarily limited to expressly listed steps or units but may include other steps or units that are not expressly listed or that are inherent to such process, method, product, or device.

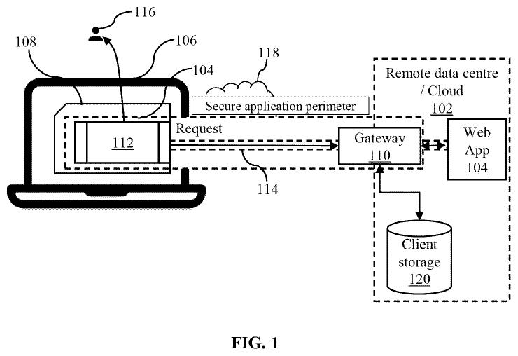

FIG. 1 illustrates a system for accessing a web application 104 running in a remote data centre 102 at a client endpoint device 106 running a first web browser 108 in accordance with an implementation of the disclosure. The system sends a request to access the web application (e.g. a web app) 104 to a gateway 110 at the remote data centre 102. The system receives hypervisor script code from the gateway 110 in response to the request. The system executes the received hypervisor script code at the client endpoint device 106 using the first web browser 108. Execution of the received hypervisor script code, by the system, causes the client endpoint device 106 to: (i) retrieve a second web browser 112 from the gateway 110 at the remote data centre 102; (ii) launch the retrieved second web browser 112 at the client endpoint device 106 within the first web browser 108; and (iii) establish a secure application access tunnel connection 114 via the second web browser 112 to the gateway 110. The system displays, on a screen of the client endpoint device 106, a graphical image of a user interface screen of the web application 104 running at the remote data centre 102, by receiving user interaction events input by a user 116 of the first web browser 108 of the client endpoint device 106 and in response to such received user interaction events, the second web browser 112 fetches components of the web application 104 over the secure application access tunnel connection 114 and renders the graphical image of the user interface screen of the web application 104 by invoking an HTML canvas function of the first web browser 108.

The system reduces the total costs of service by eliminating the need for a resource layer because the web browsers (i.e. the first web browser 108 and the second web browser 112) and the web application 104 access components are running at the client endpoint device 106 and not on the enterprise resources/resource layer. The system improves security by retrieving and launching the second web browser 112 at the client endpoint device 106 within the first web browser 108 from an untrusted environment (i.e. isolating the second web browser 112 from the untrusted environment). The system improves the performance of accessing the web application 104 by rendering locally at the client endpoint device 106 instead of rendering at the remote data centre 102. The system employs any existing browser/embedded browser, thereby eliminating the need for an additional client software installation required. The system does not require any resources to allocate in remote data centre 102 per client. The system does not require an enterprise network access in the case of VPN, and no modification is needed to the web application 104. The system provides an architecture independent platform, where any client endpoint device with an installed browser (e.g. Chrome, Firefox, Edge, or Safari, etc.) can be implemented. The software may seamlessly be interpreted and executed by a JavaScript engine and therefore the method is not intrusive and does not require any change in the web application. The method provides a single management platform for the security policy that can be introduced. The method enables the execution of the web application by an isolated JavaScript engine with a local memory without access to the web application and therefore malware or malicious browser plugin cannot exploit vulnerabilities in the web application.

Optionally, the system sends the request to access the web application 104 to the gateway 110 over a network connection 118. Optionally, the hypervisor script code is JavaScript. Optionally, the secure application access tunnel connection 114 is a Virtual Private Network (VPN) tunnel connection. The gateway 110 may be a Web Application Firewall gateway or a Cloud Access Security Broker gateway. Optionally, the data that is persisted as a result of the access to the web application 104 is sent by the second web browser 112 over the secure application access tunnel connection 114 and stored at the remote data centre 102. Optionally, the data that is persisted as a result of the access to the web application 114 is stored at a database of a client storage 120. Optionally, the data that is persisted as a result of the access to the web application 104 is encrypted by the second web browser 112 and stored locally at the client endpoint device 106. Optionally, the second web browser 112 is in a Web Assembly format (WASM).

Optionally, a user interaction event interface of the second web browser 112 is exposed to the first web browser 108. A canvas interface of the second web browser 112 may be exposed to the first web browser 108. A VPN client may be included in the second web browser 112. Optionally, the data that is persisted includes at least one of cookies, a Document Object Model tree and a content downloaded via the web application 104.

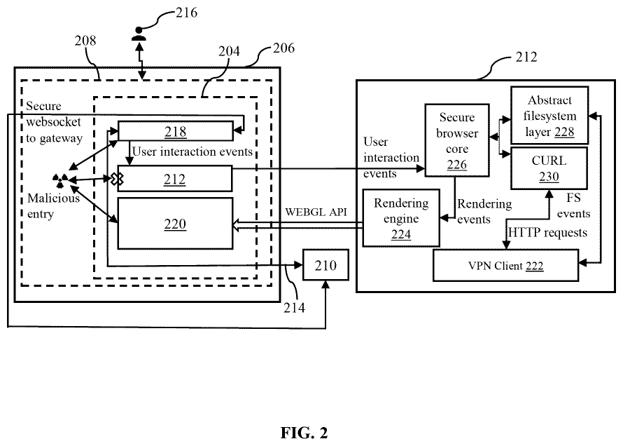

FIG. 2 illustrates a client endpoint device 206 running a first web browser 208 for accessing a web application 204 running in a remote data centre in accordance with an implementation of the disclosure. The client endpoint device 206 sends a request to access the web application 204 to a gateway 210 which is located at the remote data centre (not shown in FIG. 2). The client endpoint device 206 receives a hypervisor script code 218 from the gateway 210 in response to the request. The client endpoint device 206 executes the received hypervisor script code 218 at the client endpoint device 206 using the first web browser 208. Executing the received hypervisor script code 218 causes the client endpoint device 206 to: (i) retrieve a second web browser 212 from the gateway 210 at the remote data centre; (ii) launch the retrieved second web browser 212 at the client endpoint device 206 within the first web browser 208; and (iii) establish a secure application access tunnel connection 214 via the second web browser 212 to the gateway 210. The client endpoint device 206 displays, on a screen of the client endpoint device 206, a graphical image of a user interface screen of the web application 204 running at the remote data centre, by receiving user interaction events input by a user 216 of the first web browser 208 of the client endpoint device 206 and in response to such received user interaction events, the second web browser 212 fetches components of the web application 204 over the secure application access tunnel connection 214 and renders the graphical image of the user interface screen of the web application 204 by invoking an HTML canvas function 220 of the first web browser 208.

The client endpoint device 206 reduces the total costs of service by eliminating the need for a resource layer because the web browsers (i.e. the first web browser 208 and the second web browser 212) and the web application 204 access components are running at the client endpoint device 206 and not on the enterprise resources/resource layer. The client endpoint device 206 improves security by retrieving and launching the second web browser 212 at the client endpoint device 206 within the first web browser 208 from an untrusted environment (i.e. isolating the second web browser 212 from the untrusted environment). The client endpoint device 206 improves the performance of accessing the web application 204 by rendering locally at the client endpoint device 206 instead of rendering at the remote data centre. The client endpoint device 206 employs any existing browser/embedded browser, thereby eliminating the need for an additional client software installation required.

The client endpoint device 206 enables the user 216/employee to access the web application 204 (e.g. an enterprise web application) without installing any additional software such as plugins/Virtual Private Network/browser/Virtual Desktop Interface client. The client endpoint device 206 provides a single management platform for the security policy that can be introduced. The client endpoint device 206 employs the second web browser 212/embedded secure browser that is executed within the first web browser 208 of the client endpoint device 206 for accessing the web application 204. This makes the client endpoint device 206 a hardware/architecture independent for accessing the web application 204. The hypervisor script code 218 controls an interface between the first web browser 208 and the second web browser 212/embedded secure browser.

Optionally, the client endpoint device 206 includes a network access layer to a preconfigured gateway/the gateway 210. The web application 204 may be accessed by the hypervisor script code 218 that is provided by the gateway 210/central enterprise gateway. The second web browser 212/embedded secure browser may ensure the secure and encrypted communication to the remote data centre. Optionally, a file access layer may be implemented over the gateway 210 (e.g. a central enterprise gateway).

Optionally, the hypervisor script code 218 is JavaScript. Optionally, the secure application access tunnel connection 214 is a Virtual Private Network (VPN) tunnel connection. The gateway 210 may be a Web Application Firewall gateway or a Cloud Access Security Broker gateway.

Optionally, in response to the received user interaction events, the second web browser 212 fetches components of the web application 204 over the secure application access tunnel connection 214 using a secure browser core 226 which is part of the second web browser 212 (i.e. the right hand side of FIG. 2 shows an enlarged, or blow up depiction, of the second web browser 212 which is shown in summary format on the left hand side of FIG. 2). Optionally, the second web browser 212 includes a rendering engine 224 for rendering the graphical image of the user interface screen of the web application 204 by invoking the HTML canvas function 220 of the first web browser 208 and in response to the rendering events from the secure browser core 226, the rendering engine 224 within the second web browser 212/embedded secure browser may render the page as a canvas (e.g. the HTML canvas) and send it to the first web browser 208 as a picture through a web Graphics Library Application programming interface (WEBGL API). Therefore, the first web browser 208 running on the client endpoint device 206 does not have access to a protected enterprise web content, such as the document object model (DOM) tree or cookie information. The WEBGL API is a JavaScript API for rendering high-performance interactive three dimensional (3D) and two dimensional (2D) graphics within any compatible web browser without the use of plugins.

Optionally, the data that is persisted as a result of the access to the web application 204 is sent by the second web browser 212 over the secure application access tunnel connection 214 via the gateway 210 and stored at the remote data centre. Optionally, the data that is persisted as a result of the access to the web application 204 is encrypted by the second web browser 212 and stored locally at the client endpoint device 206. The data that is persisted may be encrypted by using a temporal provided enterprise key. Optionally, the second web browser 212 is in a Web Assembly format (WASM).

Optionally, a user interaction event interface of the second web browser 212 is exposed to the first web browser 208. A canvas interface of the second web browser 212 may be exposed to the first web browser 208. Optionally, the user interaction event interface and the canvas interface could be used by malicious entities and an untrusted user. A VPN client 222 may be included in the second web browser 212. Optionally, the data that is persisted includes at least one of cookies, a Document Object Model tree and a content downloaded via the web application 204. Optionally, the second web browser 212 further includes an abstract file system layer 228 and an application content delivery layer for a client uniform resource locator (CURL) 230.

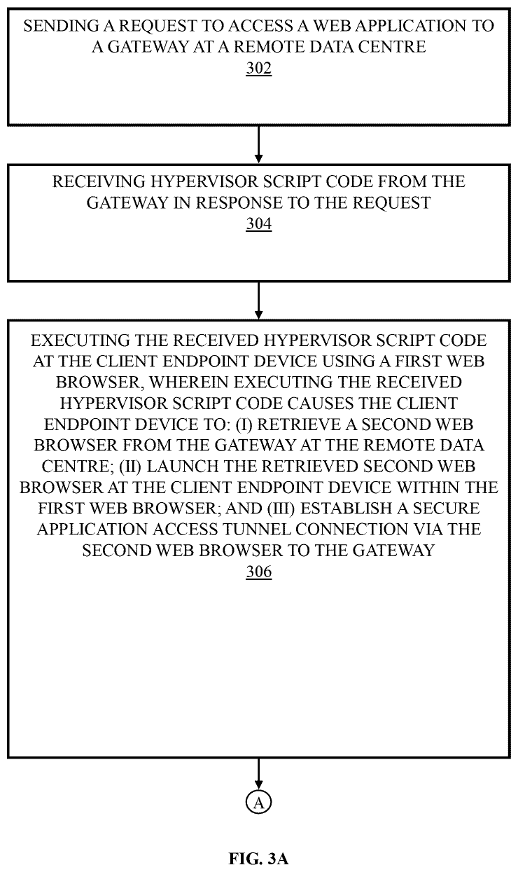

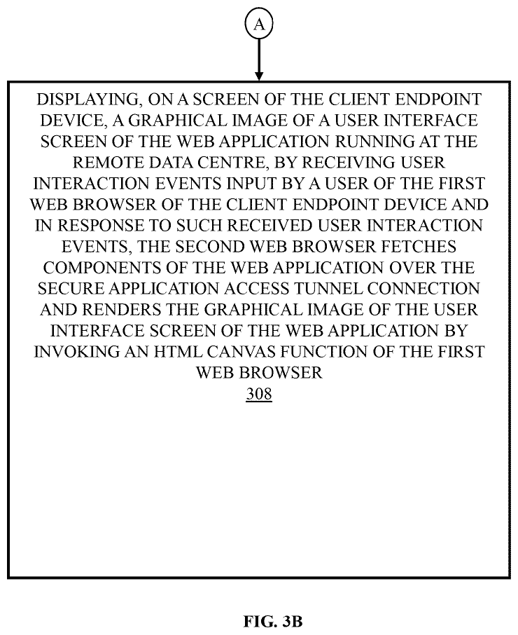

FIGS. 3A-3B are flow diagrams that illustrate a method of accessing, at a client endpoint device running a first web browser, a web application running in a remote data centre in accordance with an implementation of the disclosure. Starting first with FIG. 3A, at a step 302, a request to access the web application is sent to a gateway at the remote data centre by a client endpoint device. At a step 304, a hypervisor script code is received from the gateway in response to the request by the client endpoint device. At a step 306, the received hypervisor script code is executed at the client endpoint device using the first web browser. Executing the received hypervisor script code causes the client endpoint device to: (i) retrieve a second web browser from the gateway at the remote data centre; (ii) launch the retrieved second web browser at the client endpoint device within the first web browser; and (iii) establish a secure application access tunnel connection via the second web browser to the gateway. Moving now to FIG. 3B, at a step 308, a graphical image of a user interface screen of the web application running at the remote data centre is displayed on a screen of the client endpoint device, by receiving user interaction events input by a user of the first web browser of the client endpoint device and in response to such received user interaction events, the second web browser fetches components of the web application over the secure application access tunnel connection and renders the graphical image of the user interface screen of the web application by invoking a HTML canvas function of the first web browser.

The method reduces the total costs of service by eliminating the need for a resource layer because the web browsers (i.e. the first and second web browsers) and the web application access components are running at the client endpoint device and not on the enterprise resources/resource layer. The method improves security by retrieving and launching the second web browser at the client endpoint device within the first web browser from an untrusted environment (i.e. isolating the second web browser from the untrusted environment). The method improves the performance of accessing the web application by rendering locally at the client endpoint device instead of rendering at the remote data centre. The method employs any existing browser/embedded browser, thereby eliminating the need for an additional client software installation required. The method provides an architecture independent platform, where any client endpoint device with an installed browser (e.g. Chrome, Firefox, Edge, or Safari, etc.) can be implemented. The method may seamlessly be interpreted and executed by a JavaScript engine and therefore the method is not intrusive and does not require any change in the web application. The method provides a single management place for the security policy that can be introduced. The method enables the execution of the web application only an isolated JavaScript engine with a local memory without access to the web application and therefore malware or malicious browser plugin cannot exploit vulnerabilities in the web application.

The method enables a policy-controlled output of information such as a printer, a clipboard device and a storage device. The method enables data access policies to allow users to save data locally at the client endpoint device. For example, a user (e.g. an employee) wants to save his paycheck on the client endpoint device itself. The method provides a zero configuration framework (i.e. without the need to install any additional software such as plugins/Virtual Private Network/browser/Virtual Desktop Interface client) to enable users to use and leverage enterprise web application from the untrusted source/environment. The client endpoint device can use any enterprise web application after an authentication process and no further actions are required. The method enables a secure access for any public web application.

The method provides a new architecture for the enterprise web application over a virtual embedded browser, thereby significantly reducing the operational cost. The method is a managed service (i.e. policy change may be enforced immediately) and controls the data lost prevention strategies. The method employs an embedded secure browser/the second web browser that is executed within the first browser that is installed on the client endpoint device for accessing the web application. The secure second web browser can be provided as a service for private customers. Optionally, the secure application access tunnel connection is a Virtual Private Network (VPN) tunnel connection. The gateway may be a Web Application Firewall gateway or a Cloud Access Security Broker gateway.

Optionally, the data that is persisted as a result of the access to the web application is sent by the second web browser over the secure application access tunnel connection and stored at the remote data centre. Optionally, the data that is persisted as a result of the access to the web application is encrypted by the second web browser and stored locally at the client endpoint device. Optionally, the second web browser is in a Web Assembly format.

Optionally, a user interaction event interface of the second web browser is exposed to the first web browser. A canvas interface of the second web browser may be exposed to the first web browser. A VPN client may be included in the second web browser. Optionally, the data that is persisted includes at least one of cookies, a Document Object Model tree and a content downloaded via the web application.

In an embodiment, a computer program is provided comprising instructions for carrying out all the steps of the above described method, when the computer program is executed on a computer system

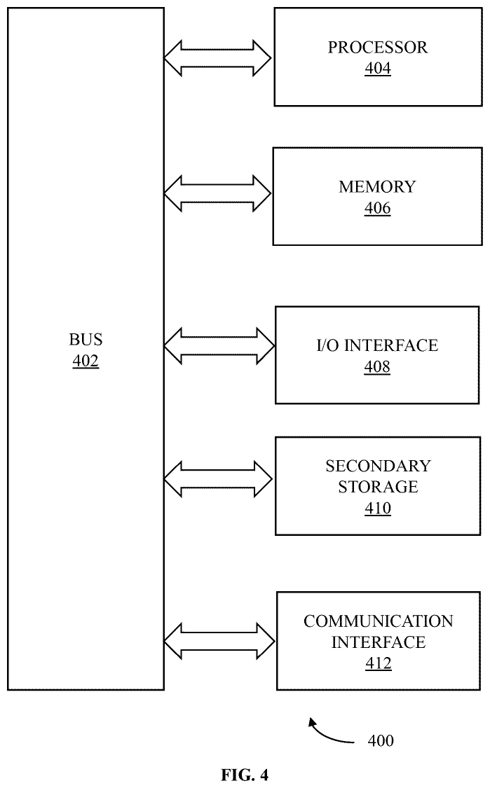

FIG. 4 is an illustration of a computer system (e.g. a client endpoint device) in which the various architectures and functionalities of the various previous implementations may be implemented. As shown, the computer system 400 includes at least one processor 404 that is connected to a bus 402, wherein the computer system 400 may be implemented using any suitable protocol, such as PCI (Peripheral Component Interconnect), PCI-Express, AGP (Accelerated Graphics Port), Hyper Transport, or any other bus or point-to-point communication protocol(s). The computer system 400 also includes a memory 406.

Control logic (software) and data are stored in the memory 406 which may take a form of random-access memory (RAM). In the disclosure, a single semiconductor platform may refer to a sole unitary semiconductor-based integrated circuit or chip. It should be noted that the term single semiconductor platform may also refer to multi-chip modules with increased connectivity which simulate on-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The computer system 400 may also include a secondary storage 410. The secondary storage 410 includes, for example, a hard disk drive and a removable storage drive, representing a floppy disk drive, a magnetic tape drive, a compact disk drive, digital versatile disk (DVD) drive, recording device, universal serial bus (USB) flash memory. The removable storage drive at least one of reads from and writes to a removable storage unit in a well-known manner.

Computer programs, or computer control logic algorithms, may be stored in at least one of the memory 406 and the secondary storage 410. Such computer programs, when executed, enable the computer system 400 to perform various functions as described in the foregoing. The memory 406, the secondary storage 410, and any other storage are possible examples of computer-readable media.

In an implementation, the architectures and functionalities depicted in the various previous figures may be implemented in the context of the processor 404, a graphics processor coupled to a communication interface 412, an integrated circuit (not shown) that is capable of at least a portion of the capabilities of both the processor 404 and a graphics processor, a chipset (namely, a group of integrated circuits designed to work and sold as a unit for performing related functions, and so forth).

Furthermore, the architectures and functionalities depicted in the various previous-described figures may be implemented in a context of a general computer system, a circuit board system, a game console system dedicated for entertainment purposes, an application-specific system. For example, the computer system 400 may take the form of a desktop computer, a laptop computer, a server, a workstation, a game console, an embedded system.

Furthermore, the computer system 400 may take the form of various other devices including, but not limited to a personal digital assistant (PDA) device, a mobile phone device, a smart phone, a television, and so forth. Additionally, although not shown, the computer system 400 may be coupled to a network (for example, a telecommunications network, a local area network (LAN), a wireless network, a wide area network (WAN) such as the Internet, a peer-to-peer network, a cable network, or the like) for communication purposes through an I/O interface 408.

It should be understood that the arrangement of components illustrated in the figures described are exemplary and that other arrangement may be possible. It should also be understood that the various system components (and means) defined by the claims, described below, and illustrated in the various block diagrams represent components in some systems configured according to the subject matter disclosed herein. For example, one or more of these system components (and means) may be realized, in whole or in part, by at least some of the components illustrated in the arrangements illustrated in the described figures.

In addition, while at least one of these components are implemented at least partially as an electronic hardware component, and therefore constitutes a machine, the other components may be implemented in software that when included in an execution environment constitutes a machine, hardware, or a combination of software and hardware.

Although the disclosure and its advantages have been described in detail, it should be understood that various changes, substitutions, and alterations can be made herein without departing from the spirit and scope of the disclosure as defined by the appended claims.

1. A method of accessing, at a client endpoint device running a first web browser, a web application running in a remote data centre, the method comprising:
sending a request to access the web application to a gateway at the remote data centre;
receiving hypervisor script code from the gateway in response to the request;
executing the received hypervisor script code at the client endpoint device using the first web browser, wherein executing the received hypervisor script code causes the client endpoint device to:
retrieve a second web browser from the gateway at the remote data centre;
launch the retrieved second web browser at the client endpoint device within the first web browser; and
establishing a secure application access tunnel connection via the second web browser to the gateway; and
displaying, on a screen of the client endpoint device, a graphical image of a user interface screen of the web application running at the remote data centre, by receiving user interaction events input by a user of the first web browser of the client endpoint device and in response to the received user interaction events, the second web browser fetches components of the web application over the secure application access tunnel connection and renders the graphical image of the user interface screen of the web application by invoking a HyperText Markup Language (HTML) canvas function of the first web browser.

2. The method of claim 1, wherein the secure application access tunnel connection is a Virtual Private Network (VPN) tunnel connection.

3. The method of claim 1, wherein the gateway is a Web Application Firewall gateway or a Cloud Access Security Broker gateway.

4. The method of claim 1, wherein data persisted as a result of the access to the web application is sent by the second web browser over the secure application access tunnel connection and stored at the remote data centre.

5. The method of claim 1, wherein data persisted as a result of the access to the web application is encrypted by the second web browser and stored locally at the client endpoint device.

6. The method of claim 1, wherein the second web browser is in a Web Assembly format.

7. The method of claim 1, wherein a user interaction event interface of the second web browser is exposed to the first web browser.

8. The method of claim 1, wherein a canvas interface of the second web browser is exposed to the first web browser.

9. The method of claim 1, wherein a VPN client (222) is included in the second web browser.

10. The method of claim 4, wherein the data persisted includes at least one of cookies, a Document Object Model tree and a content downloaded via the web application.

11. A system comprising at least a client endpoint device running a first web browser, accessing a web application running in a remote data centre adapted for carrying out the method according to claim 1.

12. A non-transitory computer readable medium comprising computer-executable instructions, which upon being executed by a computer system, cause the computer system to perform a method including:
sending a request to access a web application to a gateway at a remote data centre;
receiving hypervisor script code from the gateway in response to the request;
executing the received hypervisor script code at the client endpoint device using the first web browser, wherein executing the received hypervisor script code causes the client endpoint device to:
retrieve a second web browser from the gateway at the remote data centre;
launch the retrieved second web browser at the client endpoint device within the first web browser; and
establishing a secure application access tunnel connection via the second web browser to the gateway; and
displaying on a screen of the client endpoint device, a graphical image of a user interface screen of the web application running at the remote data centre, by receiving user interaction events input by a user of the first web browser of the client endpoint device and in response to the received user interaction events, the second web browser fetches components of the web application over the secure application access tunnel connection and renders the graphical image of the user interface screen of the web application by invoking a HyperText Markup Language (HTML) canvas function of the first web browser.

13. A client endpoint device running a first web browser, accessing a web application running in a remote data centre, configured to:
send a request to access the web application to a gateway at the remote data centre;
receive hypervisor script code from the gateway in response to the request;
execute the received hypervisor script code at the client endpoint device using the first web browser, wherein executing the received hypervisor script code causes the client endpoint device to:
retrieve a second web browser from the gateway at the remote data centre;
launch the retrieved second web browser at the client endpoint device within the first web browser; and
establish a secure application access tunnel connection via the second web browser to the gateway; and
display, on a screen of the client endpoint device, a graphical image of a user interface screen of the web application running at the remote data centre, by receiving user interaction events input by a user of the first web browser of the client endpoint device and in response to such received user interaction events, the second web browser fetches components of the web application over the secure application access tunnel connection and renders the graphical image of the user interface screen of the web application by invoking a HyperText Markup Language (HTML) canvas function of the first web browser.

14. The non-transitory computer readable medium of claim 12, wherein the secure application access tunnel connection is a Virtual Private Network (VPN) tunnel connection.

15. The non-transitory computer readable medium of claim 12, wherein the gateway is a Web Application Firewall gateway or a Cloud Access Security Broker gateway.

16. The non-transitory computer readable medium of claim 12, wherein data persisted as a result of the access to the web application is sent by the second web browser over the secure application access tunnel connection and stored at the remote data centre.

17. The non-transitory computer readable medium of claim 12, wherein data persisted as a result of the access to the web application is encrypted by the second web browser and stored locally at the client endpoint device.

18. The device of claim 13, wherein the secure application access tunnel connection is a Virtual Private Network (VPN) tunnel connection.

19. The device of claim 13, wherein the gateway is a Web Application Firewall gateway or a Cloud Access Security Broker gateway.

20. The device of claim 13, wherein data persisted as a result of the access to the web application is sent by the second web browser over the secure application access tunnel connection and stored at the remote data centre.
